(19) United States
(12) Patent Application Publication
(10) Pub. No.: US 2008/0267215 A1
(43) Pub. Date: Oct. 30, 2008

(54) System and method of identifying a location associated with a source of a data communication problem

(75) Inventors: Stuart Blackburn, San Ramon, CA (US); John Van Slyke, Lafayette, CA (US); Raghvendra Savoor, Walnut Creek, CA (US); Stephen Sposato, Lafayette, CA (US)

Correspondence Address: TOLER LAW GROUP, 8500 BLUFFSTONE COVE, SUITE A201, AUSTIN, TX, 78759, US

(73) Assignee: AT&T Knowledge Ventures, L.P., Reno, NV (US)

(21) Appl. No.: 11/799,109

(22) Filed: Apr. 30, 2007

(51) Int. Cl. H04J 3/16

(52) U.S. Cl. 370/468

(57) ABSTRACT

In a particular illustrative embodiment, a method is disclosed that includes receiving data at a central server system from multiple customer premises equipment (CPE) devices. The CPE devices are located at subscriber premises remote from one another. The method further includes associating the received data from geographically-related CPE devices and comparing the associated data to determine a problem related to one or more of the geographically-related CPE devices.

### FIELD OF THE DISCLOSURE

The present disclosure is generally related to systems and methods of identifying a location associated with a source of a data communication problem.

### BACKGROUND

In general, a perceived quality of a data communications service depends, in part, on the speed of the service. Such speed may be impacted by impairments within the communication network. For example, problems between a central office and a customer premises (i.e., outside plant problems), may reduce data communication speeds. Additionally, the speed of the data communications service may be impaired by elements within the customer premises, such as poor wiring, faulty equipment, etc. Hence, there is a need for a system and method of identifying a location associated with a source of a data communication problem.

### BRIEF DESCRIPTION OF THE DRAWINGS

FIG. 1 is a block diagram of a particular illustrative embodiment of a system to identify a location associated with a source of a data communication problem;

FIG. 2 is a flow diagram of a first particular illustrative embodiment of a method of identifying a location associated with a source of a data communication problem;

FIG. 3 is a flow diagram of a second particular illustrative embodiment of a method of identifying a location associated with a source of a data communication problem; and

FIG. 4 is a block diagram of a particular illustrative embodiment of a general computing system.

### DETAILED DESCRIPTION OF THE DRAWINGS

In a particular illustrative embodiment, a method is disclosed that includes receiving data at a server system from multiple customer premises equipment (CPE) devices. The CPE devices are located at customer premises remote from one another. The method further includes comparing data received from geographically-related CPE devices, and identifying a location associated with a source of a data communication problem related to one or more of the geographically-related CPE devices.

In another particular illustrative embodiment, a method is provided that includes collecting data at an interface between a number of customer premises and a network. The data includes first data related to a first customer premises equipment (CPE) device at a first location and second data related to a second CPE device at a second location. The method further includes comparing the first data and the second data to identify a location associated with a source of a data communication problem related to the first CPE device.

In yet another particular illustrative embodiment, a system is disclosed that includes processing logic and memory accessible to the processing logic. The memory includes instructions executable by the processing logic to execute a method that includes collecting data from multiple customer premises equipment (CPE) devices located remotely from each other at multiple customer premises at an interface between the multiple subscriber premises and a network. The method also includes evaluating data related to a first CPE device relative to data related to at least one second CPE device of the multiple CPE devices to identify a location associated with a source of a data communication problem.

In still another particular illustrative embodiment, a processor-readable medium is disclosed that includes instructions executable by a processor to identify a location associated with a source of a data communication problem. The processor-readable instructions are executable by the processor to perform a method that includes receiving data at a server system from multiple customer premises equipment (CPE) devices. The CPE devices are located at customer premises remote from one another. The method further includes comparing data received from geographically-related CPE devices and identifying a location associated with a source of a data communication problem related to one or more of the geographically-related CPE devices.

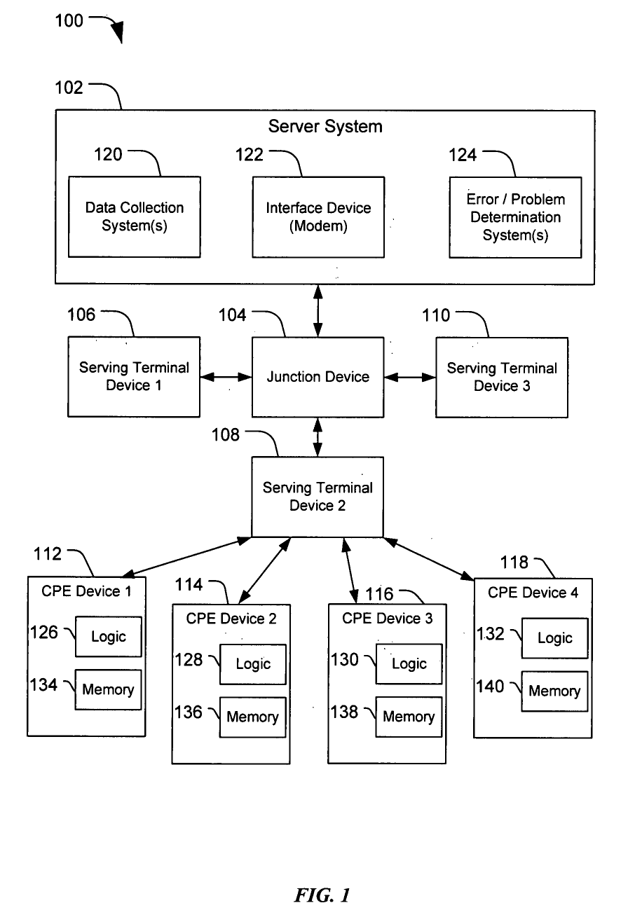

FIG. 1 is a block diagram of a particular illustrative embodiment of a system 100 to identify a source of data communications problems. The system 100 includes a server system 102 that communicates with a junction device 104, which communicates with one or more serving terminal devices 106, 108, and 110. The serving terminal devices 106, 108, and 110 communicate with one or more customer premises equipment (CPE) devices via twisted-pair wiring. For example, the serving terminal device 108 communicates with CPE devices 112, 114, 116, and 118. In general, the cables, conduits, ducts, poles, towers, repeaters, repeater huts, interconnection panels, and other equipment located between the server system 102 at a central office and a connection point (such as a network interface device (NID) or a CPE device at a customer premises) may be referred to as an outside plant. Service impairments or problems at a CPE device, such as the CPE device 112, may be the result of bad wiring, faulty equipment, or poor installation at the customer premises and may therefore result in a service-related charge to a subscriber account of a customer associated with the CPE device 112, when a service technician is dispatched to fix the problem. Such problems may be distinguished from service impairments or problems within the outside plant, which are typically the responsibility of the service provider.

The server system 102 includes one or more servers adapted to provide various services, such as broadband Internet access services. In a particular illustrative embodiment, the junction device 104 and the serving terminal devices 106, 108, and 110 may represent physical devices that can couple CPE devices, such as the CPE devices 112, 114, 116, and 118, to the server system 102 via wiring. The junction device 104 may be adapted to couple multiple serving terminal devices, such as the terminal serving devices 106, 108, and 110, to trunk wiring for communication with the server system 102. In a particular illustrative embodiment, the junction device 104 may be called a B-box device. In a particular embodiment, the junction device 104, the serving terminal devices 106, 108, and 110, and associated cabling, such as cabling between the server system 102 and the CPE devices 112, 114, 116, and 118, are included in the outside plant.

The server system 102 includes data collection systems 120 to collect data from one or more of the CPE devices 112, 114, 116, and 118. The server system 102 also includes an interface device 122, such as a modem (e.g., a digital subscriber line access multiplexer (DSLAM)). The server system 102 may also include error/problem determination systems 124, which can be utilized to analyze collected data that is retrieved by the data collection systems 120 to determine service-related problems, such as a location associated with a source of a data communication problem. In a particular illustrative embodiment, the server system 102 can utilize the data collection systems 120 and the error/problem determination systems 124 to automatically identify a location associated with a source of a data communication problem, without having to dispatch a technician to obtain measurements.

In a particular illustrative embodiment, each CPE device can include logic and a memory to measure various parameters associated with a transmission line coupled to the CPE device. For example, the CPE devices 112, 114, 116, and 118 include logic 126, 128, 130, and 132 and memory 134, 136, 138 and 140, respectively. In a particular illustrative example, the logic 126 of the CPE device 112 can measure one or more transmission line characteristics and store data related to such measurements in the memory 134. In a particular illustrative embodiment, the CPE devices 112, 114, 116 and 118 may be set-top box devices that are adapted to provide a broadband connection to an Internet Service Provider and to decode broadcast television signals or Internet Protocol Television (IPTV) signals and to provide the decoded television signals to a display device or to a digital video recorder (DVR) module.

In a particular illustrative embodiment, the data collection system 120 communicates with the interface device 122 to send requests to each of the CPE devices 112, 114, 116, and 118. In a particular illustrative embodiment, the server system 102 may poll each CPE device 112, 114, 116, and 118 to obtain data related to transmission quality between the interface device 122 and the CPE devices 112, 114, 116, and 118.

In a particular illustrative embodiment, the server system 102 may request data associated with a particular performance parameter. In another particular illustrative embodiment, the server system 102 may obtain data related to multiple performance parameters. For example, the data collected by the data collection systems 120 can include a line status, down stream and up stream current bit rates, down stream and up stream transmitted signal powers, down stream and up stream noise margins, down stream and up stream signal attenuation values, down stream and up steam relative capacity occupations, down stream line code violations, down stream line errors, cross talk data, estimated loop length, counter information related to down stream DSL cell transmissions, down stream line code violation interval counts, down stream line forward error correction codes, other data, or any combination thereof. Such data collected from the CPE devices 112, 114, 116, and 118 may include raw measurement data, calculated values, or any combination thereof.

The system 100 may utilize the error/problem determination systems 124 to detect impairments or service-related problems between the server system 102 and each of the CPE devices 112, 114, 116, and 118 based on the collected data. For example, the error/problem determination systems 124 can analyze the collected data from CPE device 112 relative to collected data from the CPE devices 114, 116, and 118 to determine whether a source of a service-related impairment is common to the CPE devices 112, 114, 116, and 118 or whether the source is unique to the CPE device 112. If the impairment is common to the CPE devices 112, 114, 116, and 118, the source of the impairment may be a bridged tap or other impairment between the server system 102 and the serving terminal device 108 (i.e., in the outside plant). If the impairment is unique to the CPE device 112, the source of the impairment is likely to be at the customer premises, such as a wiring problem at the customer premises, an improperly installed filter, other impairments, or any combination thereof. In a particular illustrative embodiment, the CPE devices 112, 114, 116, and 118 are neighboring CPE devices, in that such CPE devices share a common trunk line, a common junction, a common serving terminal, or any combination thereof. In another particular illustrative embodiment, neighboring CPE devices may also include CPE devices that are located within a geographical area, within a logical area (such as service area defined by a service provider), or any combination thereof.

In a particular illustrative embodiment, the server system 102 can monitor transmission quality between the various CPE devices 112, 114, 116, and 118 and the server system 102 to proactively detect and resolve service-related problems. In some instances, the the server system 102 may detect a service-related problem in the outside plant and issue a work order that results in repairs being made before the problem is detected by a customer. Additionally, since the server system 102 can determine the source of the service-related problem, a customer service representative can inform a customer where the problem resides (e.g., within the customer premises or within the outside plant). When such problems reside within a customer premises, service of such problems may cause expenses to the customer.

In a particular illustrative embodiment, the server system 102 can allow a customer service representative to inform the customer before such expenses are incurred. In a particular illustrative, non-limiting embodiment, the server system 102 may provide a graphical user interface to a computing device that includes information to identify the source of the service-related problem. For example, a customer service representative may access the graphical user interface to obtain information about the service-related problem and to provide such information to a customer. In another example, the customer may access the graphical user interface to obtain information about the service-related problem to self-diagnose the problem.

In a particular illustrative environment, a source of a service-related impairment may exist in the outside plant between a subscriber premises and the serving terminal device 108. In particular embodiment, sources of service-related impairments can include bridged taps, poor bonding, poor grounding, improperly installed or missing filters at the customer premises, impairments in wiring or equipment at the customer's premises (for example, untwisted wires, or wires that run next to a source of an electrical disturbance, such as halogen lights or refrigerators), other impairments, or any combination thereof. Some such impairments may exist in the outside plant and may be under control of a telephone company, a DSL provider, another communication service provider, or any combination thereof. Others may be inside a customer premises and may not be under the control of the service provider.

In a particular illustrative embodiment, the error/problem determination system 124 may identify lines with inside wire problems that would conventionally require a technician to visit the customer premises. In a particular illustrative embodiment, the error/problem determination system 124 may detect poor filters (plain old telephone service filters or alarm filters) and other inside wire problems based on a significantly increased attenuation in both up stream and down stream data signals. The error/problem determination system 124 may compare the up stream and down stream attenuation of a particular CPE device, such as the CPE device 112, with that of geographically-related devices (e.g., CPE devices that share a common line, a common cable, lines in the serving terminal, lines in a taper code or lines in a common distribution area, other commonalities, or any combination thereof), such as the CPE devices 114, 116, and 118. In a particular illustrative embodiment, the error/problem determination system 124 can compare the up stream and down stream attenuation values of the CPE device 112 to a statistical representation of the attenuation value of the other CPE devices 114, 116, and 118, such as a median attenuation value. For example, when the CPE device 112 has an associated attenuation value that is above the median attenuation value, the error/problem determination system 124 can identify that a problem exists at the customer premises.

In a particular illustrative embodiment, the server system 102 utilizes the data collections systems 120 to access or retrieve the already stored information at the CPE devices 112, 114, 116, and 118 and processes the retrieved data using the error/problem determination system 124 to identify problems. In a particular embodiment, such problems can be identified in response to a customer complaint call, e.g., while a customer is on the phone. In another embodiment, such problems can be identified automatically. For example, each customer premises equipment device may be polled or queried from time to time (e.g., periodically), allowing the service provider to proactively identify and flag service-related problems.

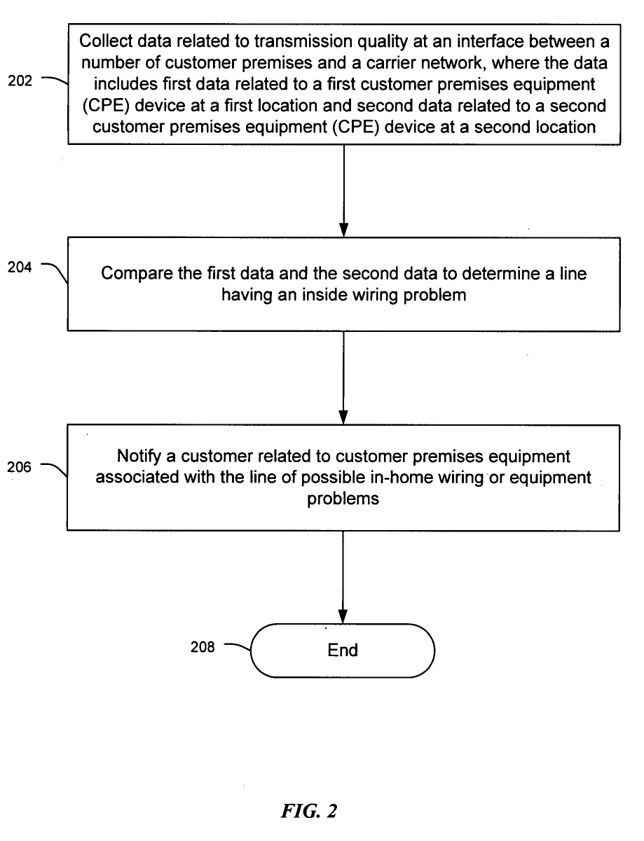

FIG. 2 is a flow diagram of a particular illustrative embodiment of a method to identify a source of data communications problems. At 202, data is collected at an interface between a number of customer premises and a carrier network. The data includes first data related to a first customer premises equipment (CPE) device at a first location and second data related to a second customer premises equipment (CPE) device at a second location. In a particular illustrative embodiment, the system can poll the first CPE device and the second CPE device to collect the first and second data. In another particular illustrative embodiment, the first and second data may be retrieved from a memory. In a particular illustrative embodiment, the data may be related to transmission quality. For example, the data may include a bit rate, a signal power value, a maximum attainable bit rate, a signal attenuation value, a noise margin value, other values, or any combination thereof.

Advancing to 204, the first data and the second data are compared to determine a line having an inside wiring problem. For example, the problem may be a service related issue associated with a first location. In another example, the problem may be a service related issue between a service terminal of a service provider and the first CPE device. Advancing to 206, a customer related to a customer premises equipment device associated with the line is notified of possible in-home wiring or equipment problems. For example, a notification may include information that identifies a location associated with a source of a data communication problem. In a particular example, the location may be associated with the first location that is associated with the first CPE device. In another particular example, the location may be within an outside plant associated with the service provider. The method terminates at 208. In a particular illustrative embodiment, the method may also include generating a work order to initiate a repair by a technician to address the identified data communication problem.

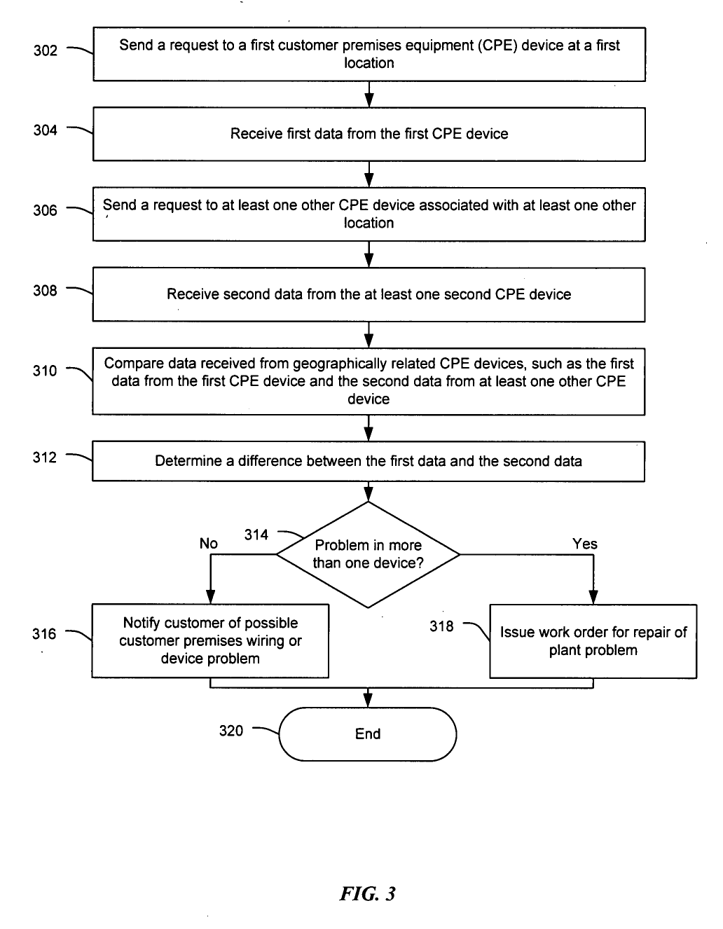

FIG. 3 is a flow diagram of a second particular illustrative embodiment of a method of identifying a source of data communications problems. At 302, a first request is sent to a first customer premises equipment (CPE) device at a first location. Proceeding to 304, first data is received from the first CPE device. Advancing to 306, a second request is sent to at least one other CPE device associated with at least one other location. Moving to 308, second data is received from the other CPE device.

Proceeding to 310, data is compared from geographically-related CPE devices, such as the first data from the first CPE device and to second data from the other CPE device. In a particular illustrative embodiment, at least one other CPE device may include one or more geographically-related CPE devices. Geographically-related CPE devices can include CPE devices that are located within a logical distribution area associated with the first CPE device. The one or more geographically-related CPE devices may also include CPE devices that are associated with one or more lines from a common cable, lines in a serving terminal, lines in a taper code, or any combination thereof. In another particular embodiment, the one or more geographically-related CPE devices may include CPE devices that are associated with a particular geographic area, such as a township, a defined community, a particular residential development, or any combination thereof. Customer premises that are adjacent to one another (i.e., next door neighbors) are also likely to share a common serving terminal device, a common junction, or a common trunk line. In a particular illustrative embodiment, transmission quality data derived from the geographically-related CPE devices may be compared to identify a location associated with a source of a data communication problem (e.g., to determine whether a source of a data communication problem is associated with the outside plant or a customer premises). In a particular illustrative embodiment, the comparison includes comparing first attenuation data related to the first CPE device with second attenuation data related to one or more geographically-related CPE devices. In a particular example, first attenuation data may be compared to a statistical value, such as a median value of the attenuation data values from the geographically-related CPE devices.

Advancing to 312, a difference between the first data and the second data is determined. The difference may be analyzed to determine whether the difference indicates a data communication problem associated with the first CPE device or whether such a problem is shared among CPE devices. In a particular illustrative embodiment, the data communication problem may be identified based on a differential attenuation relative to one or more geographically-related CPE devices that is greater than or equal to approximately 3 decibels (3 dB). Other thresholds may also be used, particularly where differences in respective loop lengths from a serving terminal to respective CPE devices of the one or more geographically-related CPE devices may account for as much as 3 dB of signal attenuation. In a particular example, any detectable difference can serve as a threshold from which a data communication problem may be inferred.

Continuing to 314, if the system determines that a problem exists in only one device, the method advances to 316 and the system notifies the customer of possible customer premises wiring or device problem. Otherwise at 318, the system issues a work order for repair of a plant related problem. The method terminates at 320.

In conjunction with the configuration of structure described herein, the systems and methods disclosed include a server system to receive data from multiple customer premises equipment (CPE) devices, which can be located at subscriber premises remote from one another. The server system is adapted to associate the received data from geographically-related CPE devices and to compare the associated data to determine a problem related to one or more of the geographically-related CPE devices. In a particular illustrative non-limiting embodiment, the server system may be adapted to correlate received data from the multiple CPE devices to determine whether a source of a service-related problem is located within a customer premises or is associated with physical devices and/or wiring of the outside plant (i.e., associated with a service provider). The server system may be adapted to generate a work order to initiate a service repair by a technician, when the identified source is associated with the service provider. When the server system determines that the identified source is within the customer premises, the server system can notify a customer services representative, who may initiate a call to the customer premises to address the service-related problem.

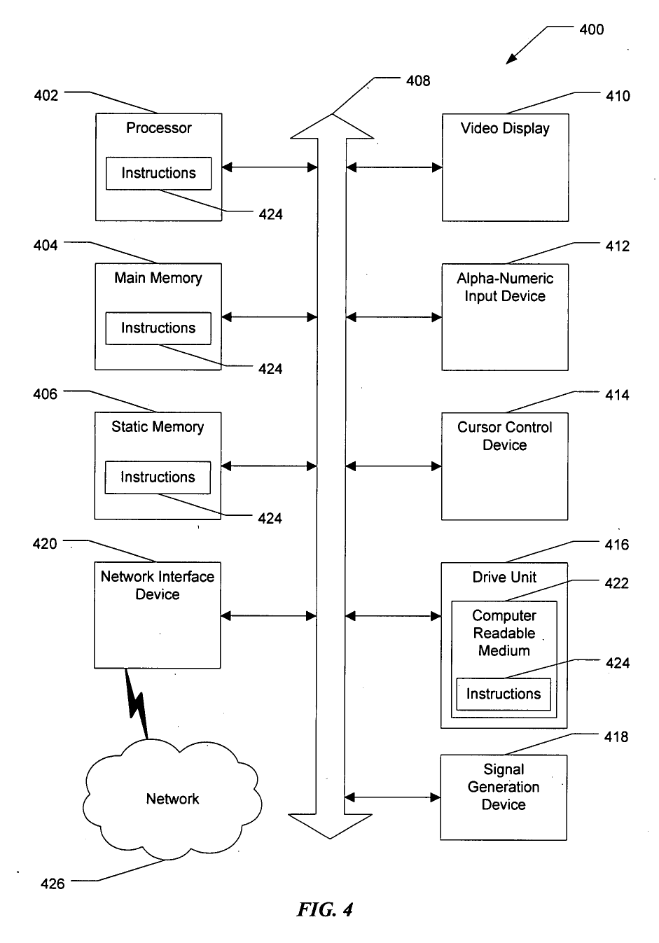

Referring to FIG. 4, an illustrative embodiment of a general computer system is shown and is designated 400. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. For example, the computer system 400 may include or be included within any one or more of the server system, data collection systems, interface devices, error/problem determination systems, serving systems, or CPE devices illustrated and described with reference to FIG. 1.

In a networked deployment, the computer system may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. Moreover, the computer system 400 can include a main memory 404 and a static memory 406, that can communicate with each other via a bus 408. As shown, the computer system 400 may further include a video display unit 410, such as a liquid crystal display (LCD), an organic light emitting diode (OLED), a flat panel display, a solid-state display, or a cathode ray tube (CRT). Additionally, the computer system 400 may include an input device 412, such as a keyboard, and a cursor control device 414, such as a mouse. The computer system 400 can also include a disk drive unit 416, a signal generation device 418, such as a speaker or remote control, and a network interface device 420.

In a particular embodiment, as depicted in FIG. 4, the disk drive unit 416 may include computer-readable media 422 in which one or more sets of instructions 424, e.g. software, can be embedded. Further, the instructions 424 may embody one or more of the methods or logic as described herein. In a particular embodiment, the instructions 424 may reside completely, or at least partially, within the main memory 404, the static memory 406, and/or within the processor 402 during execution by the computer system 400. The main memory 404 and the processor 402 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 424 or receives and executes instructions 424 responsive to a propagated signal, so that a device connected to a network 426 can communicate voice, video or data over the network 426. Further, the instructions 424 may be transmitted or received over the network 426 via the network interface device 420.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
receiving data at a server system from multiple customer premises equipment (CPE) devices, the CPE devices located at customer premises remote from one another;
comparing data received from geographically-related CPE devices; and
identifying a location associated with a source of a data communication problem related to one or more of the geographically-related CPE devices.

2. The method of claim 1, further comprising:
receiving first data from a first CPE device at a first location in response to a first request sent to the first CPE device; and
receiving second data from a second CPE device at a second location in response to a second request sent to the second CPE device.

3. The method of claim 2, further comprising determining a difference between the first data and the second data.

4. The method of claim 1, wherein comparing data received from the geographically-related CPE devices comprises comparing first attenuation data related to a first CPE device with second attenuation data related to one or more second CPE devices.

5. The method of claim 4, wherein the one or more second CPE devices are located within a distribution area associated with the first CPE device.

6. The method of claim 4, wherein the one or more second CPE devices comprise CPE devices that are associated with one of lines from a common cable, lines in a serving terminal, and lines in a taper code.

7. The method of claim 4, wherein comparing comprises determining whether an attenuation differential value between an attenuation value of the first CPE device and attenuation values of the one or more second CPE devices is greater than or equal to approximately three decibels (3 dB), wherein the attenuation differential value cannot be accounted for based on differences in respective loop lengths associated with the first CPE device and the one or more second CPE devices.

8. A method comprising:
collecting data at an interface between a number of customer premises and a network, wherein the data comprises first data related to a first customer premises equipment (CPE) device at a first location and second data related to a second CPE device at a second location; and
comparing the first data and the second data to identify a location associated with a source of a data communication problem related to the first CPE device.

9. The method of claim 8, wherein the data comprises information related to transmission quality for the first CPE device.

10. The method of claim 8, further comprising polling the first CPE device and the second CPE device.

11. The method of claim 8, wherein the problem comprises a wiring or equipment problem at a customer premises associated with the first location.

12. The method of claim 11, further comprising notifying a customer related to the first CPE device that the problem is associated with the first location.

13. The method of claim 8, wherein the problem comprises a wiring or equipment problem within an outside plant between a service provider and the first CPE device.

14. The method of claim 13, further comprising generating a work order for a technician to repair the problem within the outside plant.

15. The method of claim 8, further comprising initiating collecting the data and comparing the first data and the second data without receiving a request from a customer related to the first CPE device or the second CPE device.

16. The method of claim 8, wherein the first data and the second data comprise bit rate data.

17. The method of claim 8, wherein the first data and the second data comprise signal power data.

18. The method of claim 8, wherein the first data and the second data comprise attainable bit rate data.

19. The method of claim 8, wherein the first data and the second data comprise signal attenuation data.

20. The method of claim 8, wherein the first data and the second data comprise noise margin data.

21. A system comprising:
processing logic and memory accessible to the processing logic, the memory including instructions executable by the processing logic to execute a method comprising:
collecting data from multiple customer premises equipment (CPE) devices located remotely from each other at multiple subscriber premises at an interface between the multiple customer premises and a network; and
evaluating data related to a first CPE device relative to data related to at least one second CPE device of the multiple CPE devices to identify a location associated with a source of a data communication problem.

22. The system of claim 21, further comprising instructions executable by the processing logic to poll the multiple CPE devices.

23. The system of claim 22, further comprising instructions executable by the processing logic to collect the data, wherein the data comprises first data related to the first CPE device at a first customer premises and second data related to the at least one second CPE device at a second customer premises.

24. The system of claim 21, wherein the interface comprises a digital subscriber line access multiplexer (DSLAM) device.

25. The system of claim 21, wherein the first CPE device comprises a digital subscriber line (DSL) modem.

26. The system of claim 21, wherein the source of the data communication problem comprises a bridged tap.

27. The system of claim 21, wherein the source of the data communication problem comprises an untwisted wire.

28. The system of claim 21, wherein the source of the data communication problem comprises a filter installation problem at a subscriber premises.

29. A processor-readable medium comprising instructions executable by a processor to identify a location associated with a source of a data communication problem, the processor-readable instructions executable by the processor to perform a method comprising:
receiving data at a server system from multiple customer premises equipment (CPE) devices, the CPE devices located at customer premises remote from one another;
comparing data received from geographically-related CPE devices; and
identifying a location associated with a source of a data communication problem related to one or more of the geographically-related CPE devices.

30. The method of claim 29, wherein comparing data received from the geographically-related CPE devices comprises comparing first attenuation data related to a first CPE device with second attenuation data related to one or more second CPE devices.
